(19) United States
(12) Patent Application Publication
(10) Pub. No.: US 2008/0026687 A1
(43) Pub. Date: Jan. 31, 2008

(54) Passage opening and closing apparatus

(75) Inventor: Hiromitsu Maehata, Anjo-city (JP)

Correspondence Address: HARNESS, DICKEY & PIERCE, P.L.C., P.O. BOX 828, BLOOMFIELD HILLS, MI, 48303, US

(73) Assignee: DENSO Corporation, Kariya-city (JP)

(21) Appl. No.: 11/880,630

(22) Filed: Jul. 23, 2007

(30) Foreign Application Priority Data
Jul. 25, 2006 (JP) 2006-201848

(51) Int. Cl. B60H 1/24; F24F 13/08

(52) U.S. Cl. 454/69; 454/195

(57) ABSTRACT

A passage opening and closing apparatus has a case defining an opening, a door for opening and closing the opening and a driving device for rotating the door. A first end of a rotation shaft of the door is rotatably supported by the case, and a second end of the rotation shaft is coupled to the driving device. The door has a door-sealing part along an edge of the door main body, the edge extending in an axial direction. The door-sealing part contacts a case-sealing surface on a periphery of the opening when the door closes the opening. The door-sealing part is inclined such that a distance between the door-sealing surface and the case-sealing surface reduces from a driving side toward a non-driving side that is farther away than the driving side with respect to the driving device.

### CROSS REFERENCE TO RELATED APPLICATION

This application is based on Japanese Patent Application No. 2006-201848 filed on Jul. 25, 2006, the disclosure of which is incorporated herein by reference.

### FIELD OF THE INVENTION

The present invention relates to a passage opening and closing apparatus, which is used, for example, for an inside/outside air switching device of a vehicular air conditioning apparatus. More particularly, the present invention relates to a sealing structure of the passage opening and closing apparatus.

### BACKGROUND OF THE INVENTION

A sealing structure of an inside/outside air switching device for a vehicular air conditioning apparatus is disclosed, for example, in Unexamined Japanese Patent Publication No. 2000-211339. In the disclosed inside/outside air switching device, an inside air suction port and an outside air suction port of a case are opened and closed by a rotary door.

The rotary door generally includes a rotation shaft, a peripheral wall extending in a door rotational direction and fan-shaped side walls connecting axial ends of the peripheral wall and ends of the rotation shaft. The rotary door has a door sealing part along edges of the peripheral wall and the side walls. The door sealing part is provided by an elastic sealing member. The case has case sealing surfaces on peripheries of the inside and outside air suction ports. When the rotary door closes one of the inside air suction port and the outside air suction port, the door sealing part is brought into contact with the case sealing surface of the corresponding one of the inside air suction port and the outside air suction port. In other words, the door sealing part elastically contacts the case sealing surface so as to seal the corresponding air suction port.

In this rotary door, a first end of the rotation shaft is rotatably supported by the case, and a second end of the rotation shaft is coupled to a driving device. When the rotary door is rotated by the driving device, a driving force of the driving device is likely to be transmitted more to a driving side of the rotary door that is adjacent to the driving device than to a non-driving side of the rotary door that is further from the driving device. Thus, the rotary door will be deformed such that it is twisted in the door rotational direction. As a result, on the non-driving side of the rotary door, a pressing force for pressing the door sealing part against the case sealing surface is likely to be reduced. Therefore, a sealing effect will be insufficient on the non-driving side.

In order to provide the sealing effect uniformly from the driving side to the non-driving side, it is proposed to incline the case sealing surface such that a non-driving end of the case sealing surface, which is on a side opposite to the driving device, is located closer to the door sealing part than a driving end of the case sealing surface, which is on a side adjacent to the driving device. That is, the case sealing surface is inclined such that a distance between the case sealing surface and the door sealing part reduces with a distance from the driving device. In this case, even when the rotary door is twisted, the door sealing part is brought into contact with the case sealing surface even on the non-driving side.

### SUMMARY OF THE INVENTION

According to a first aspect of the present invention, a passage opening and closing apparatus has a case, which defines a passage through which a fluid flows and an opening in communication with the passage, a rotary door for opening and closing the opening, and a driving device for driving the rotary door. The rotary door includes a rotation shaft, a peripheral wall, a first side wall and a second side wall. The rotation shaft includes a first shaft end that is rotatably supported by the case and a second shaft end that is coupled to the driving device. The peripheral wall is disposed at a predetermined distance from the rotation shaft in a radial direction and rotatable with the rotation shaft. The first side wall connects a first axial end of the peripheral wall and the first shaft end of the rotation shaft. The second side wall connects a second axial end of the peripheral wall and the second shaft end of the rotation shaft. The case has a case-sealing surface on a periphery of the opening. The door has a peripheral wall-sealing part along an edge of the peripheral wall. The peripheral wall-sealing part has a door-sealing surface that elastically contacts the case-sealing surface when the door is disposed in a closed position at which the door closes the opening. The door-sealing surface is configured to incline such that a distance between the door-sealing surface and the case-sealing surface reduces toward a second end of the peripheral wall-sealing part from a first end of the peripheral wall-sealing part in a condition that the rotary door is in a position at which the door-sealing surface is separated from the case-sealing surface. The first end of the peripheral wall-sealing part is located farther than the second end of the peripheral wall-sealing part, with respect to the driving device.

Namely, the peripheral wall sealing surface is inclined such that the distance between the peripheral wall sealing surface and the case sealing surface reduces from a driving side that is closer to the driving device toward a non-driving side that is further from the driving device. As such, even when the door is twisted, the peripheral wall sealing part is sufficiently brought into contact with the case-sealing surface even on the non-driving side. Thus, a sealing effect is uniformly provided from the driving side to the non-driving side without inclining the case-sealing surface.

According to a second aspect of the present invention, a passage opening and closing apparatus has a case, a door and a driving device for rotating the door. The case defines a passage through which a fluid flows and an opening in communication with the passage. The door includes a rotation shaft, a door main body integrated with the rotation shaft to be rotatable with the rotation shaft. The rotation shaft includes a first shaft end that is rotatably connected to the case and a second shaft end that is coupled to the driving device. The case has a case-sealing surface on a periphery of the opening. The door has a door-sealing part along at least an edge of the door main body, the edge extending in a direction parallel to a rotation axis of the rotation shaft. The door sealing part elastically contacts the case-sealing surface when the door is in a closed position at which the door main body closes the opening. The door-sealing part is configured to incline such that a distance between the door sealing surface and the case sealing surface reduces from a second end of the edge of the door main body toward a first end of the edge of the door main body in a condition that the door is in a position at which the door-sealing part is separated from the case-sealing surface. The first end of the edge of the door main body is located farther than the second end of the edge of the door main body, with respect to the driving device.

Namely, the portion of the door-sealing part, which extends along the edge that extends in the axial direction, is inclined such that the distance between the door-sealing part and the case-sealing surface reduces from a driving side that is closer to the driving device toward a non-driving side that is further from the driving device. As such, even when the door is twisted, the door-sealing part is sufficiently brought into contact with the case-sealing surface even on the non-driving side. Thus, a sealing effect is uniformly provided from the driving side to the non-driving side without inclining the case sealing surface.

### BRIEF DESCRIPTION OF THE DRAWINGS

Other objects, features and advantages of the present invention will become more apparent from the following detailed description made with reference to the accompanying drawings, in which like parts are designated by like reference numbers and in which:

FIG. 1 is a schematic perspective view of an indoor unit of a vehicular air conditioning apparatus mounted on a vehicle according to a first embodiment of the present invention;

FIG. 2 is a schematic cross-sectional view of a blower unit with an inside/outside air switching device of the indoor unit according to the first embodiment;

FIG. 3 is a perspective view of the inside/outside air switching device according to the first embodiment;

FIG. 4 is a perspective view of a case of the inside/outside air switching device according to the first embodiment;

FIG. 5 is a front view of a rotary door of the inside/outside air switching device according to the first embodiment;

FIG. 6 is a schematic cross-sectional view of the rotary door taken along a line VI-VI in FIG. 5;

FIG. 7 is an enlarged cross-sectional view of a portion of the rotary door, the portion denoted by a circle VII in FIG. 6, according to the first embodiment;

FIG. 8 is a perspective view of the rotary door according to the first embodiment;

FIG. 9 is a schematic cross-sectional view of a portion of the inside/outside air switching device in an outside air mode according to the first embodiment;

FIG. 10 is a schematic cross-sectional view of the portion of the inside/outside air switching device in an inside air mode according to the first embodiment;

FIG. 11 is an enlarged cross-sectional view of a portion of a rotary door of an inside/outside air switching device according to a second embodiment of the present invention;

FIG. 12 is an enlarged cross-sectional view, of a portion of an inside/outside air switching device according to a third embodiment of the present invention; and

FIG. 13 is an enlarged cross-sectional view of a portion of an inside/outside air switching device according to a fourth embodiment of the present invention.

### DETAILED DESCRIPTION OF EXEMPLARY EMBODIMENTS

### First Embodiment

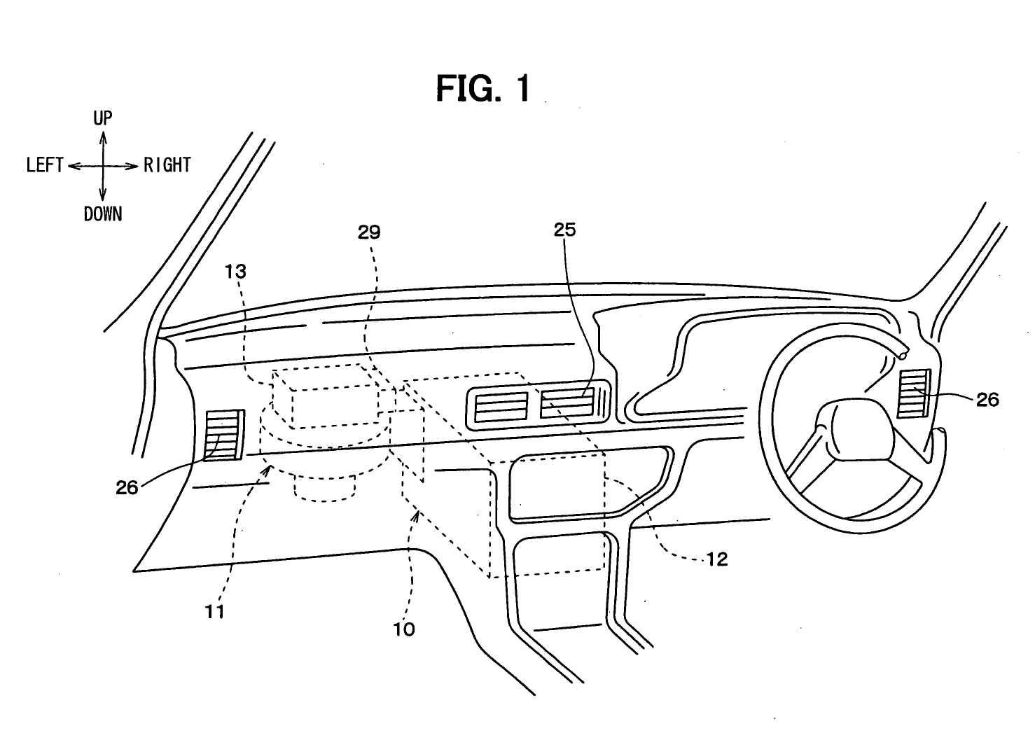

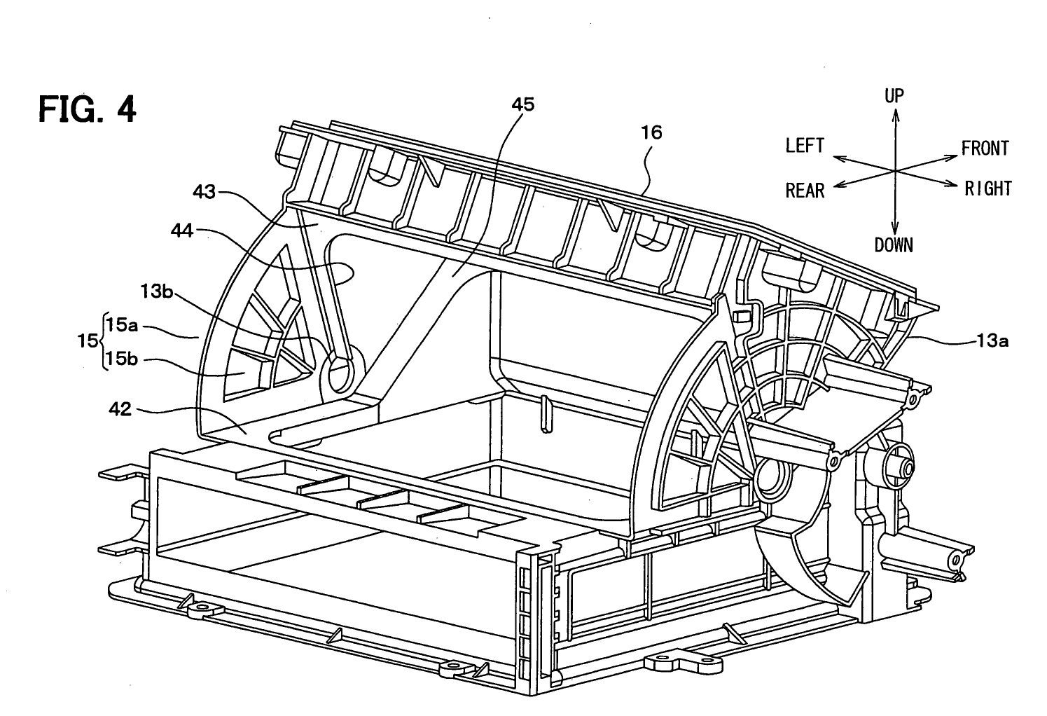

A first embodiment of the present invention will be described with reference to FIGS. 1 to 10. As shown in FIG. 1, an indoor unit 10 of a vehicular air conditioning apparatus generally includes a blower unit 11 and an air conditioning unit 12. The blower unit 11 draws inside air and/or outside air and blows the air toward the air conditioning unit 12, and the air conditioning unit 12 conditions the temperature of the air and introduces the air into a passenger compartment of a vehicle. In the drawings, up and down, left and right, front and rear arrows denote respective directions when the indoor unit 10 is mounted on a vehicle.

FIG. 1 shows an example of a front part of a vehicle that has a steering wheel on a right-hand side (hereafter, right-hand-drive vehicle). The air conditioning unit 12 is mounted at a substantially middle position with respect to a vehicle right and left direction and the blower unit 11 is mounted on a left side of the air conditioning unit 12, i.e., in front of a front passenger's seat. In a case that the indoor unit 10 is mounted to a vehicle that has a steering wheel on a left-hand side (hereafter, left-hand-drive vehicle), the air conditioning unit 12 is arranged at the substantially middle position with respect to the vehicle right and left direction, and the blower unit 11 is arranged on a right side of the air conditioning unit 12.

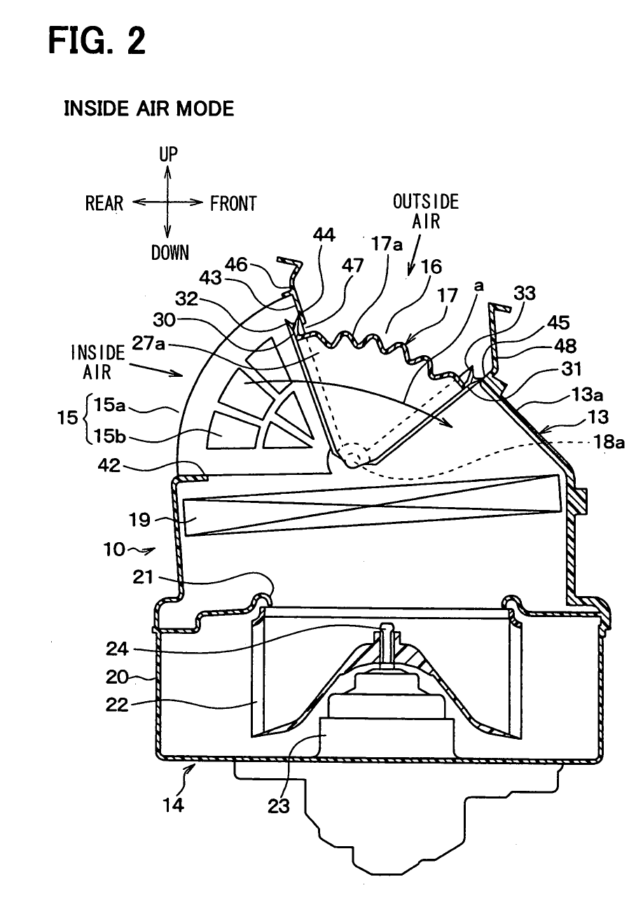

As shown in FIG. 2, the blower unit 11 generally includes an inside/outside air switching device (hereafter, air switching device) 11 and a blower 14. The air switching device 13 is mounted above the blower 14. The air switching device 13 has a resinous case 13a formed with an inside air suction port 15 as a first opening for drawing the inside air, such as air inside of the passenger compartment, therein and an outside air suction port 16 as a second opening for drawing the outside air, such as air outside of the passenger compartment, therein.

The air switching device 13 has an inside/outside air switching door 17 for opening and closing the inside air suction port 15 and the outside air suction port 16. The door 17 is rotatably housed in the case 13a. For example, the door 17 is a rotary door and has a first rotation shaft 18a, a second rotation shaft 18b and a peripheral wall 17a. The first and second rotation shafts 18a, 18b extends in the vehicle right and left direction. The peripheral wall 17a is rotatable about a rotation axis of the first and second rotation shafts 18a, 18b. The structure of the door 17 will be described later in detail.

The air switching device 13 has an air filter 19 at a position downstream of the first and second rotation shafts 18a, 18b of the door 17 for removing foreign materials such as dust from the air drawn from the inside and outside air suction ports 15, 16. The blower 14 has a resinous scroll casing 20, a fan 22 and a motor 23.

The scroll casing 20 has a bell-mouth opening 21 at a position directly downstream of the air filter 19 with respect to the flow of air. The fan 22 is for example a centrifugal multi-blade fan, such as a sirocco fan, and is arranged at a center of the scroll casing 20. The fan 22 is coupled to a rotation shaft 24 of the motor 23 and is rotated by the motor 23. With the rotation of the fan 22, the air is drawn through the opening 21 and is blown from the fan 22 in a radially outward direction.

The scroll casing 20 has an air outlet port on a right side, such as a paper face side as shown in FIG. 2. The air outlet port of the scroll casing 20 is in communication with the air conditioning unit 12. The air conditioning unit 12 accommodates a cooling heat exchanger, a heating heat exchanger, temperature adjusting devices, air blowing mode switching devices and the like therein, as well-known. Thus, the temperature of the air blown from the blower 14 is adjusted in the air conditioning unit 12 such as by cooling, dehumidifying, and/or reheating, and then the air is blown into the passenger compartment from air-blowing ports such as center face air-blowing ports 25, and side face air-blowing ports 26.

For example, the center face air-blowing ports 25 are located at a front middle position of the passenger compartment for mainly blowing cooled air toward a passenger upper body. The side face air-blowing ports 26 are located at a front left position and a front right position of the passenger compartment for mainly blowing the cooled air toward the passenger upper body or side windows. Although not illustrated, defroster air-blowing ports and foot air-blowing ports are generally provided at a position adjacent to a windshield and at lower position of the passenger compartment, respectively. From the defroster air-blowing ports, heated air is mainly blown toward an inner surface of the windshield. From the foot air-blowing ports, heated air is mainly blown toward a passenger foot area.

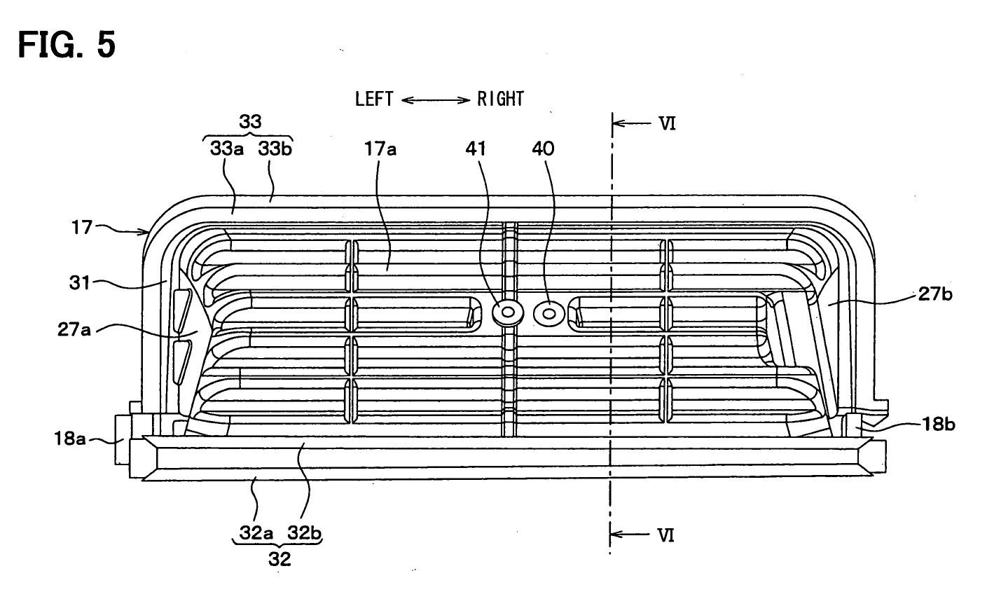

Next, the structure of the door 17 will be described in detail. As shown in FIGS. 5, 6 and 8, the door 17 has the peripheral wall 17a extending in a door rotational direction, such as a vehicle front and rear direction, and fan-shaped first and second side walls 27a, 27b extending from axial ends of the peripheral wall 17 toward the first and second rotation shafts 18a, 18b. For example, the door 17 is made of a resin, such as a polypropylene, having some strength and elasticity, similar to the case 13a. The peripheral wall 17a, the first and second rotation shafts 18a, 18b, the first and second side walls 27a, 27b are integrally molded.

In the first embodiment, the first and second rotation shafts 18a, 18b are aligned on the rotation axis, but separated from each other in an axial direction. Thus, the first and second rotation shafts 18a, 18b can be referred to as first and second ends of a rotation shaft.

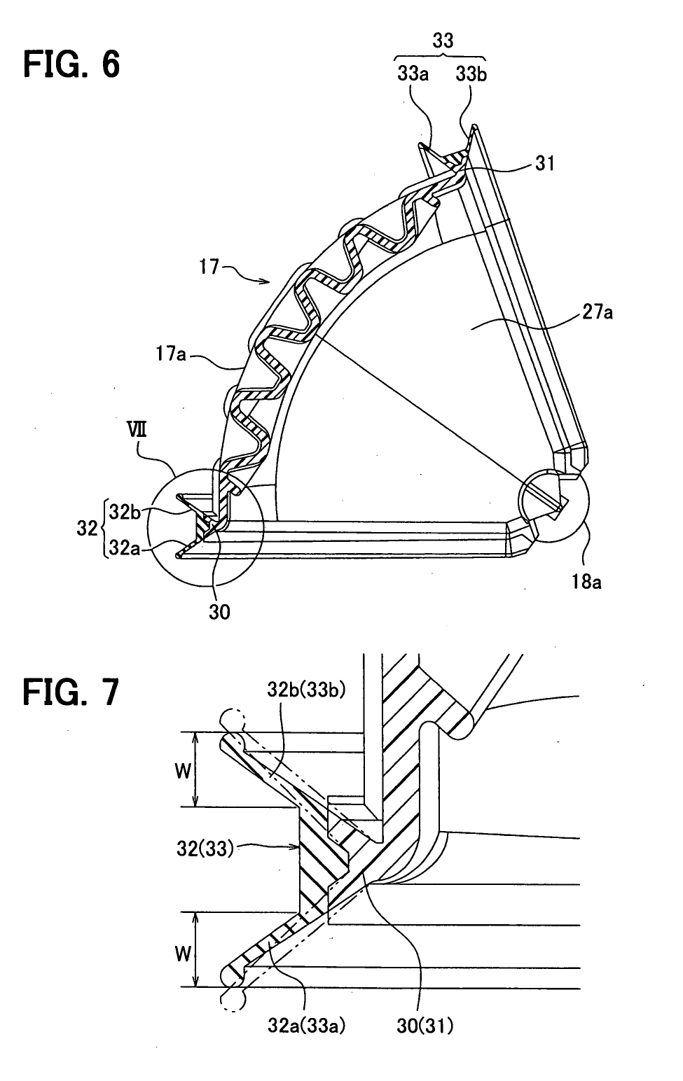

As shown in FIG. 6, the peripheral wall 17a generally has an arc shape having a radius of curvature about the rotation axis. Specifically, the peripheral wall 17a has a wave shape. With this shape, the strength of the peripheral wall 17a improves and hence deformation of the door 17 reduces. Also, in an inside air mode in which the door 17 closes the outside air suction port 16 and the inside air suction port 15 is open, noise caused by the fan 22 is reflected toward an inside of the case 13a by the wave-shaped peripheral wall 17a. Therefore, the wave-shaped peripheral wall 17a restricts the noise from introduced into the passenger compartment from the inside air suction port 15.

The first and second side walls 27a, 27b and the peripheral wall 17a provide a door main body. The door main body has a predetermined size so as to cover the inside air suction port 15, appropriately. In other words, the inside air suction port 15 is covered by the first and second side walls 27a, 27b and the peripheral wall 17a. The outside air suction port 16 is covered by the peripheral wall 17a.

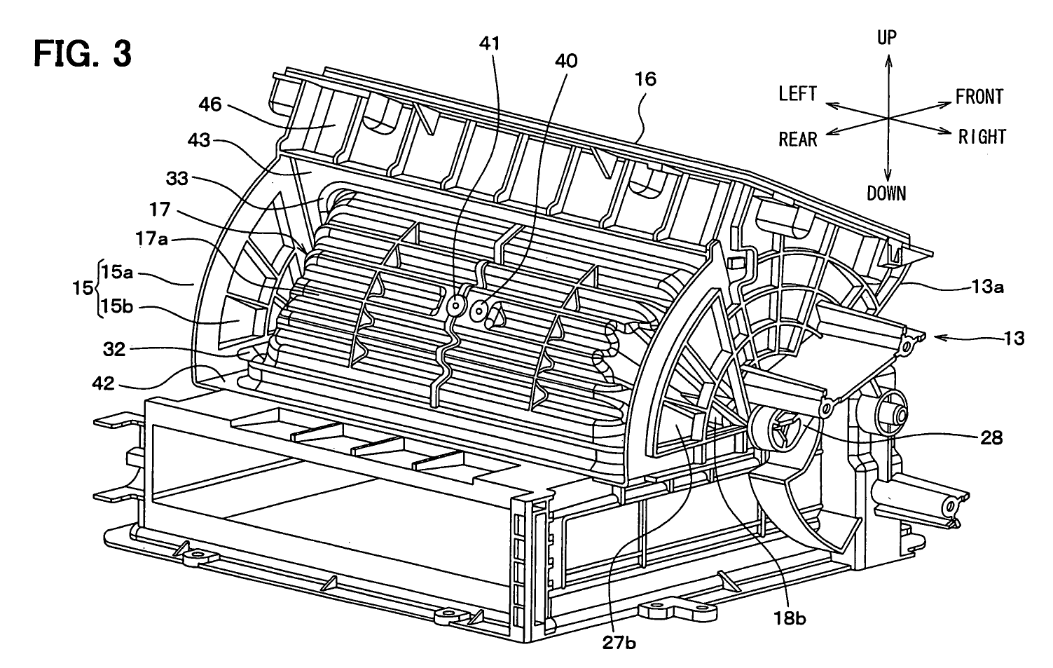

As shown in FIGS. 2 to 4, the inside air suction port 15 includes a peripheral wall opening portion 15a and side wall opening portions 15b. The side wall opening portions 15b are formed on side walls of the case 13a and are open in the vehicle right and left direction, such as in a direction perpendicular to a paper surface in FIG. 2. When the door 17 is in an outside air mode position shown in FIG. 3, the peripheral wall opening portion 15a is opposed to and covered by the peripheral wall 17a and the side wall opening portions 15b are opposed to and covered by the first and second side walls 27a, 27b.

Namely, the inside air suction port 15 opens at positions corresponding to the peripheral wall 17a and the first and second side walls 27a, 27b. Therefore, an area for drawing the inside air increases, and a maximum cooling capacity of the inside air mode improves. On the other hand, the outside air suction port 16 has a generally rectangular-shaped plane opening. The outside air suction port 16 is opposed to the peripheral wall 17a.

As described in the above, since the door 17 has the peripheral wall 17a, the first and second rotation shafts 18a, 18b and the first and second side walls 27a, 27b connecting the peripheral wall 17a and the first and second rotation shafts 18a, 18b, not only the peripheral wall opening portion 15a but also the side wall opening portions 15b opening in the axial direction are opened or covered by the door 17. With this, since the size of the opening of the inside air suction port 15 increases, the volume of inside air introduced from the inside air suction port 15 increases.

Further, the outside air is introduced in the case 13a from the outside air suction port 16 in a generally up and down direction, and the door 17 rotates in the direction that is generally perpendicular to the flow of outside air from the outside air suction port 16, such as in the vehicle front and rear direction. Therefore, dynamic pressure of the flow of the outside air will not directly affect as a door constraining force in the door rotational direction. As such, a door operation force required for operating the door 17 is reduced.

The first and second rotation shafts 18a, 18b are located at the center of rotation of the fan-shaped first and second side walls 27a, 27b, respectively. The door 7 is disposed such that the first side wall 27a and the first rotation shaft 18a are located farther away than the second side wall 27b and the second rotation shaft 18b, with respect to the air conditioning unit 12. In this embodiment, the first side wall 27a and the first rotation shaft 18a are located on a left side and the second side wall 27b and the second rotation shaft 8b are located on a right side of the peripheral wall 17a with respect to the vehicle right and left direction.

The first rotation shaft 18a projects from the first side wall 27a in an axially outward direction of the door 17. The first rotation shaft 18a is rotatably supported in a shaft-receiving hole of the case 13a.

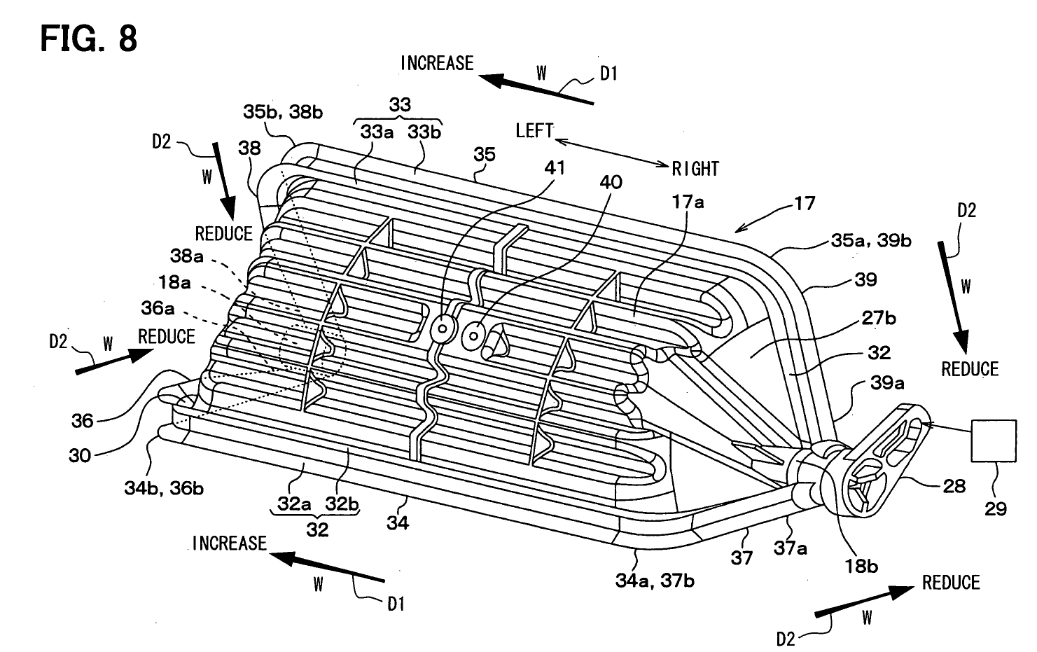

On the other hand, the second rotation shaft 18b projects from the second side wall 27b in an axially inward direction of the door 17, as shown in FIG. 8. An axial end surface of the second rotation shaft 18b is formed with an engagement hole at its center, and a shaft of a linking member 28 is received in the engagement hole of the second rotation shaft 18b. Thus, the second rotation shaft 18b is integrally coupled to the linking member 28.

As shown in FIGS. 3 and 8, the shaft of the linking member 28 extends through a shaft receiving hole of the case 13a from an outside of the case 13a and an end of the shaft of the linking member 28 is received in the engagement hole of the second rotation shaft 18b. For example, the engagement hole of the second rotation shaft 18b has a non-circular shape such as a D-shape or a tumbler-shape. The end of the shaft of the linking member 28 has a shape corresponding to the shape of the engagement hole of the second rotation shaft 18b to be engaged with the engagement hole. Thus, the rotation of the second rotation shaft 18b relative to the shaft of the linking member 28 is restricted. Namely, the second rotation shaft 18b is rotatable with the linking member 28.

The second rotation shaft 18b is coupled to a driving device 29 through the linking member 28 so that the door 17 is rotated by the driving device 29. For example, the driving device 29 is an electric actuator provided by a servomotor. Alternatively, the driving device 29 may be constructed of a manual operation device so that an operation force inputted from an inside/outside air switching operation member, such as an operation lever, provided on an air conditioner operation panel is transmitted to the second rotation shaft 18b through a cable and the linking member 28.

As shown in FIG. 1, the driving device 29 is located on a right side of the air switching device 13. In other words, the driving device 29 is located between the air switching device 13 and the air conditioning unit 12 with respect to the vehicle right and left direction. Therefore, it is less likely that a size of the indoor unit 10 will increase in the vehicle right and left direction due to the driving device 29.

Also, the door 17 provides a space between the peripheral wall 17a and the first and second side walls 27a, 27b. When the door 17 is at an inside air mode position at which the door 17 closes the outside air suction port 16 and the inside air suction port 15 is open as shown in FIG. 2, the space is communicated with the outside of the case 13a through the inside air suction port 15. Therefore, the inside air can flow through the space as shown by an arrow a in FIG. 2.

In the first embodiment, the door 17 has the two rotation shafts 18a, 18b, which are separated and located at the axial ends of the door 17. Instead, the door 17 may have one rotation shaft that continuously extends from one axial end to the opposite axial end of the door 17.

The door 17 has a sealing structure for sealing the inside air suction port 15 and the outside air suction port 16. Here, the door 17 has a lip-type sealing structure for reducing the door operation force.

As shown in FIGS. 6 and 7, the main body of the door 17, which includes the peripheral wall 17a and the first and second side walls 27a, 27b, has a first flange portion 30 and a second flange portion 31 on peripheral edges thereof. The first and second flange portions 30, 31 are integrally formed with the peripheral wall 17a and the first and second side walls 27a, 27b. Each of the first and second flange portions 30, 31 has a Y-shaped cross-section. The first and second flange portions 30, 31 are formed along opposite ends of the main body of the door 17 with respect to the door rotational direction.

Further, first and second sealing members 32, 33 are fixed to the first and second flange portions 30, 31, respectively. Each of the sealing members 32, 33 has a lip shape including thin plate-like portions.

As shown in FIG. 8, the first sealing member 32 includes a peripheral wall sealing portion 34 extending along an end of the peripheral wall 17a in the axial direction, a first side wall sealing portion 36 extending along an end of the first side wall 27a in the direction perpendicular to the axial direction, and a second side wall sealing portion 37 extending along an end of the second side wall 27b in the direction perpendicular to the axial direction.

Likewise, the second sealing member 33 includes a peripheral wall sealing portion 35 extending along an opposite end of the peripheral wall 17a in the axial direction, a first side wall sealing portion 38 extending along an opposite end of the first side wall 27a in the direction perpendicular to the axial direction, and a second side wall sealing portion 39 extending along an opposite end of the second side wall 27b in the direction perpendicular to the axial direction.

The first and second sealing members 32, 33 are made of an elastomer resin, such as a high polymer elastomeric resin. The first and second sealing members 32, 33 are integrally formed with the resinous main body of the door 17 by double-shot molding.

As shown in FIG. 7, each of the first and second sealing members 32, 33 diverges two portions and projects on opposite sides of each flange portion 30, 31 with respect to the door rotational direction. In other words, each sealing member 32, 33 has a substantially V-shaped cross-section. Thus, each sealing member 32, 33 is elastically deformable on both sides of the corresponding flange portion 30, 31 with respect to the door rotational direction.

Namely, the first sealing member 32 has a first lip portion 32a and a second lip portion 32b on opposite sides thereof with respect to the door rotational direction. Likewise, the second sealing member 33 has a first lip portion 33a and a second lip portion 33b on opposite sides thereof with respect to the door rotational direction.

Here, the double-shot molding or composite molding is a well-known method in which two different molten resins are injected into a mold so as to integrally mold two resin articles. In this embodiment, a molten resin for molding the main body of the door 17 is injected into a cavity of a mold from a first gate 40, which is located at a position corresponding to a substantially middle portion of the peripheral wall 17a, and then a molten elastomer resin for the first and second sealing members 32, 33 is injected into the cavity from a second gate 41 provided adjacent to the first gate 40 while the resin for the door main body is being solidified. Thus, the first and second sealing members 31, 32 are integrally molded with the door main body inside of the mold.

The case 13a has case sealing surfaces 42, 43, 44, 45 on peripheries of the inside and outside air suction ports 15, 16, as shown in FIG. 9. When the door 17 is in the inside air mode position or the outside air mode position, the first and second lip portions 32a, 32b, 33a, 33b of the door 17 are pressed against and in contact with the sealing surfaces 42, 43, 44, 45 in elastically deformed conditions. That is, the sealing surfaces 42, 43, 44 45 are formed at positions corresponding to the first and second lip portions 32a, 32b, 33a, 33b of the door 17 to have surface contact with the first and second lip portions 32a, 32b, 33a, 33b.

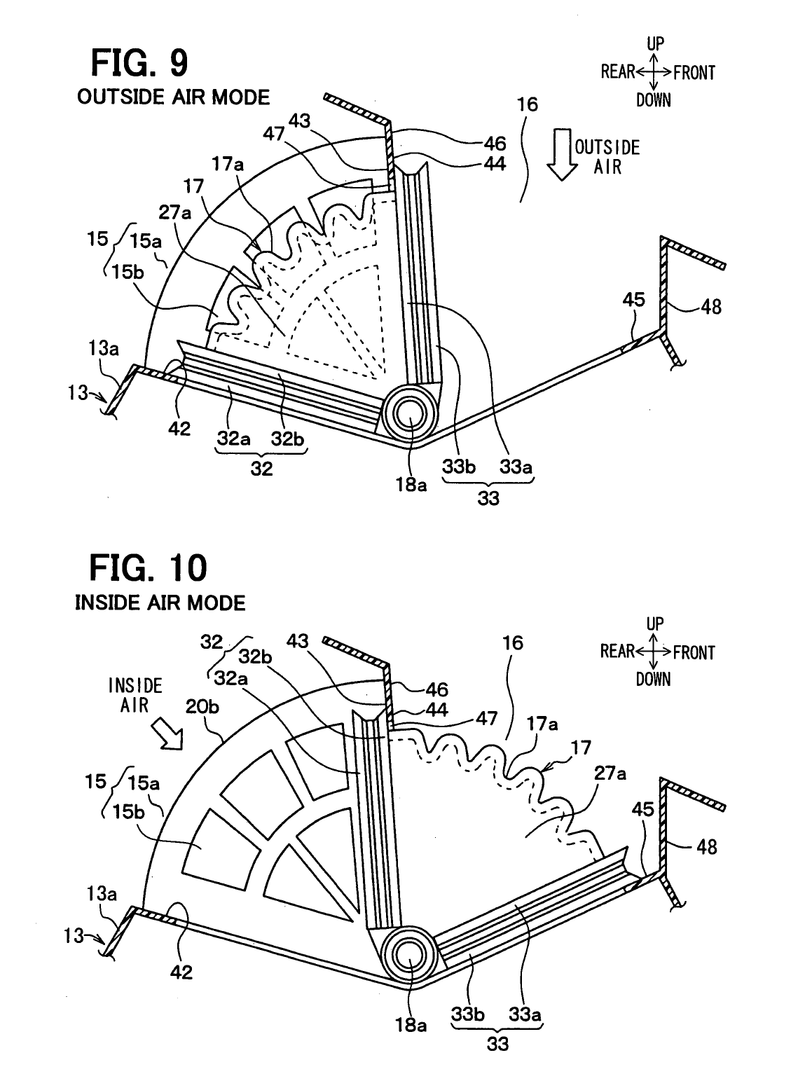

Specifically, the first lip portions 32a, 33a of the first and second sealing members 32, 33 contact the case sealing surfaces 42, 44 as first sealing surfaces when the door 17 is in the outside air mode position shown in FIG. 9. The second lip portions 32b, 33b of the first and second sealing members 32, 33 contact the case sealing surfaces 43, 45 as second sealing surfaces when the door 17 is in the inside air mode position shown in FIG. 10.

As shown in FIG. 7, each of the first and second lip portions 32a, 32b, 33a, 33b has a predetermined projection width W. The projection width W is defined by a dimension that is measured from a base point of each lip portion 32a, 32b, 33a, 33b to its tip end in the door rotational direction, such as an up and down direction as shown in FIG. 7.

Further, the projection width W of each lip portion 32a, 32b, 33a, 33b varies along the respective edge of the main body of the door 17, as shown by double dashed chain lines in FIG. 7. In other words, an angle between the first and second lip portions 32a, 32b, 33a, 33b of each sealing member 32, 33, which has the V-shaped cross-section, varies along the edge of the main body of the door 17, so that each of the first and second lip portions 32a, 32b, 33a, 33b inclines relative to the corresponding case sealing surface 42, 43, 44, 45.

Specifically, regarding the peripheral wall sealing portions 34, 35, which are portions of the first and second sealing members 32, 33 and extend in the axial direction, the projection width W of the first and second lip portions 32a, 32b, 33a, 33b increases with a distance from the driving device 29, such as in a direction shown by arrows D1. That is, in the peripheral wall sealing portions 34, 35, the projection width W of the first and second lip portions 32a, 32b, 33a, 33b increases from a driving side, which is adjacent to the driving device 29 (right side in FIG. 8), toward a non-driving side, which is farther from the driving device 29 (left side in FIG. 8).

For example, in each peripheral wall sealing wall portion 34, 35, the projection width W of its first end (non-driving side end) 34b, 35b, which is on the non-driving side, is approximately 1.1 times larger than the projection width W of its second end (driving side end) 34a, 35a, which is on the driving side.

Further, regarding the first and second side wall sealing portions 36, 37, 38, 39, which are portions of the first and second sealing members 32, 33 and extend in the radial direction, the projection width W of each of the first and second lip portions 32a, 32b, 33a, 33b reduces toward the rotation axis, i.e., reduces in a radially inward direction as shown by arrows D2 in FIG. 8.

Also, the projection width W of each of the second side wall sealing portions 37, 39 is smaller than the projection width W of each of the first side wall sealing portions 36, 38. For example, the projection width W of each second side wall sealing portion 37, 39 is approximately 0.8 times of the projection width W of each first side wall sealing portion 36, 38. Also, in each second side wall sealing portion 37, 39, the projection width W of its radially inner end 37a, 39a is approximately 0.8 times of the projection width W of its radially outer end 37b, 39b.

The projection width W of a radially inner end 36a, 38a of each first side wall sealing portion 36, 38 is approximately 1.1 times larger than the projection width W of the radially inner end 37a, 39a of each second side wall sealing portion 37, 39.

The case 13a has a first separation wall 46 between the inside air suction port 15 and the outside air suction port 16. The first separation wall 46 defines a rear end of the outside air suction port 16. The case sealing surfaces 43, 44 are provided by opposite surfaces of the first separation wall 46.

The door 17 is arranged such that the peripheral wall 17a is rotatable radially inside of an inner end of the first separation wall 46 while maintaining a clearance 47 between a radially outer surface of the peripheral wall 17a and the inner end of the first separation wall 46. Also, the case 13a has a second separation wall 48. The separation wall 48 defines a front end of the outside air suction port 16. The case sealing surface 45 is provided by a base portion of the second separation wall 48.

Although not illustrated, the case 13a is mounted in the vehicle such that the outside air suction port 16 is open below an outside air suction opening of a cowl portion of a vehicle body. Thus, the outside air is introduced in the case 13a through the outside air suction opening of the cowl portion and the outside air suction port 16.

Next, operations and effects of this embodiment will be described. FIG. 9 shows the outside air mode. In the outside air mode, the door 17 is in the outside air mode position at which the door 17 fully closes the inside air suction port 15 including the openings 15a, 15b, and the outside air suction port 16 is fully open. FIG. 10 shows the inside air mode. In the inside air mode, the door 17 is in the inside air mode position at which the door 17 fully closes the outside air suction port 16 and the inside air suction port 15 is fully open.

In the outside air mode shown in FIG. 9, the door 17 covers the inside air suction port 15 such that the first lip portion 32a of the first sealing member 32 contacts the case sealing surface 42 in an elastically deformed condition, and the first lip portion 33a of the second sealing member 33 contacts the case sealing surface 44 in an elastically deformed condition. Since each of the first lip portions 32a, 33a is inclined relative to the corresponding sealing surface 42, 44, in a condition that the lip portion 32a, 33a is separated from the sealing surface 42, 44, such as in a condition that the door 17 does not receive a driving force from the driving device 29, the following effects are provided.

The driving device 29 is coupled to one side of the door 17, such as to the second rotation shaft 18b. Therefore, when the door 17 is rotated by the driving device 29, the door 17 will be deformed such that the driving side of the door 17 is twisted against the non-driving side of the door 17 with respect to the door rotational direction.

In this embodiment, in the peripheral wall sealing portions 34, 35, the projection width W of each of the first lip portions 32a, 33a is increased from the second ends (driving side ends) 34a, 35a toward the first ends (non-driving side ends) 34b, 35b. As such, in the peripheral wall sealing portions 34, 35, each of the first lip portions 32a, 33a is inclined such that a distance between the first lip portion 32a, 33a and the corresponding case sealing surface 42, 44 in the door rotational direction reduces from the second ends 34a, 35a toward the first ends 34b, 35b.

Therefore, even when the door 17 is twisted, it is less likely that the contact of the first lip portions 32a, 33a with the case sealing surfaces 42, 44 will reduce at the first end (non-driving side ends) 34b, 35b. That is, the first lip portions 32a, 33a are sufficiently in pressed into contact with the case sealing surfaces 42, 44. In other words, in the peripheral wall sealing portions 34, 35, the sealing effect is uniformed from the driving side ends 34a, 35a to the non-driving side ends 34b, 35b.

Also, the projection width W of the first lip portions 32a, 33a of the first side wall sealing portions 36, 38 is larger than the projection width W of the first lip portions 32a, 33a of the second side wall sealing portions 37, 39. Therefore, even when the door 17 is twisted, it is less likely that the contact of the first lip portions 32a, 33a of the first side wall sealing portions 36, 38 with the case sealing surfaces 42, 44 will be reduced. That is, the first lip portions 32a, 33a of the first side wall sealing portions 36, 38 are properly in pressure contact with the case sealing surfaces 42, 44. Accordingly, the sealing effects are uniform between the first side wall sealing portions 36, 38 on the non-driving side and the second side wall sealing portions 37, 39 on the driving side.

In the first and second side wall sealing portions 36, 37, 38, 39, in a case that the projection width W is constant from the radially inner ends 36a, 37a, 38a, 39a to the radially outer ends 36b, 37b, 38b, 39b, while the door 17 is being moved from the inside air mode position to the outside air mode position, the radially inner ends 36a, 37a, 38a, 39a are brought into contact with the sealing surfaces 42, 44 before the radially outer ends 36b, 37b, 38b, 39b are brought into contact with the sealing surfaces 42, 44.

In this case, therefore, the amount of elastic deformation of the radially outer ends 36b, 37b, 38b, 39b is smaller than that of the radially inner ends 36a, 37a, 38a, 39a. As a result, the sealing at the radially outer ends 36b, 37b, 38b, 39b is likely to be insufficient.

In this embodiment, on the other hand, the projection width W of the first and second lip portions 32a, 32b, 33a, 33b is reduced from the radially outer ends 36b, 37b, 38b, 39b toward the radially inner ends 36a, 37a, 38a, 39a, in the first and second side wall sealing portions 36, 37, 38, 39. Therefore, it is less likely that the radially inner ends 36a, 37a, 38a, 39a will be brought into contact with the sealing surfaces 42, 44 before the radial outer ends 36b, 37b, 38b, 39b.

Therefore, the first lip portions 32a, 33a are elastically deformed uniformly from the radially inner ends 36a, 37a, 38a, 39a to the radially outer ends 36b, 37b, 38b, 39b. Accordingly, the first and second side wall sealing portions 36, 37, 38 39 are effectively in pressure contact with the sealing surfaces 42, 44.

In the inside air mode shown in FIG. 10, the door 17 covers the outside air suction port 16 such that the second lip portion 32b of the first sealing member 32 contacts the case sealing surface 43 in the elastically deformed condition and the second lip portion 33b of the second sealing member 33 contacts the case sealing surface 45 in the elastically deformed condition.

The second lip portions 32b, 33b are inclined relative to the case sealing surfaces 43, 45 in a condition that the second lip portions 32b, 33b are separated from the case sealing surfaces 43, 45. Therefore, similar to the outside air mode, even when the door 17 is twisted, the second lip portions 32b, 33b of the peripheral wall sealing portions 34, 35 provide the sealing effect uniformly from the driving side end 34a, 35a to the non-driving side end 34b, 35b. Also, the second lip portions 32b, 33b of the first and second side wall sealing portions 36, 37, 38, 39 provide the sealing effect uniformly.

Further, since the second lip portions 32b, 33b are inclined relative to the case sealing surfaces 43, 45, in the first and second side wall sealing portions 36, 37, 38, 39, the second lip portions 32b, 33b are elastically deformed uniformly from the radially inner ends 36a, 37a, 38a, 39a to the radially outer ends 36b, 37b, 38b, 39b. Therefore, the first and second side wall sealing portions 36, 37, 38, 39 are effectively sealed with the case sealing surfaces 43, 45.

The indoor unit 10 is disposed in a semi-center arrangement, in which the air conditioning unit 12 is mounted to the substantially middle position with respect to the vehicle right and left direction and the blower unit 11 is offset from the air conditioning unit 12 in the vehicle right and left direction. In the above discussion, the indoor unit 10 is employed, for example, to the right-hand-drive vehicle. Thus, the blower unit 11 is arranged on the left side of the air conditioning unit 12. The air switching device 13 is disposed above the blower 14 of the blower unit 11, and the driving device 29 is arranged on the right side of the air switching device 13.

On the other hand, when the indoor unit 10 is employed to the left-hand-drive vehicle, the air conditioning unit 12 is mounted to the substantially middle position with respect to the vehicle right and left direction and the blower unit 11 is mounted on the right side of the air conditioning unit 12. In this case, the driving device 29 is mounted on the left side of the air switching device 13. That is, the driving device 29 is mounted on an opposite side, as compared with the arrangement in the right-hand-drive vehicle.

As such, in the semi-center arrangement, the driving device 29 is arranged between the air switching device 13 and the air conditioning unit 12 in the vehicle right and left direction, on both of the right-hand-drive vehicle and the left-hand-drive vehicle. Accordingly, it is less likely that the size of the indoor unit 10 will increase due to the driving device 29.

In a case that the case 13a of the air switching device 13 is formed symmetric with respect to the vehicle right and left direction, the case 13a can be employed to both of the right-hand-drive vehicle and the left-hand-drive vehicle. Thus, efficiency for designing and manufacturing the case 13a improves.

When the air switching device 13 with the symmetric case 13a is employed to the right-hand-drive vehicle, the door 17 is assembled such that the second rotation shaft 18b is disposed on the right side to be coupled to the driving device 29 and the first rotation shaft 18a is disposed on the left side. When the air switching device 13 with the symmetric case 13a is employed to the left-hand-drive vehicle, the door 17 is assembled in the opposite direction. That is, the door 17 is assembled such that the first rotation shaft 18a is disposed on the right side and the second rotation shaft 18b is disposed on the left side to be coupled to the driving device 29.

Accordingly, the door 17 and other parts for the air switching device 13 are shared between the right-hand-drive vehicle and the left-hand-drive vehicle. Thus, efficiency for designing and manufacturing the air conditioning apparatus improves.

In a situation that the case sealing surfaces are inclined to uniform the sealing effect between the driving side and the non-driving side, instead of inclining the lip portions 32a, 32b, 33a, 33b of the sealing members 32, 33 of the door 17, the case sealing surfaces are asymmetric with respect to the axial direction of the door 17, such as, in the vehicle right and left direction. That is, the case is not symmetric with respect to the vehicle right and left direction. Therefore, the case is easily adapted to both the right-hand-drive vehicle and the left-hand-drive vehicle.

### Second Embodiment

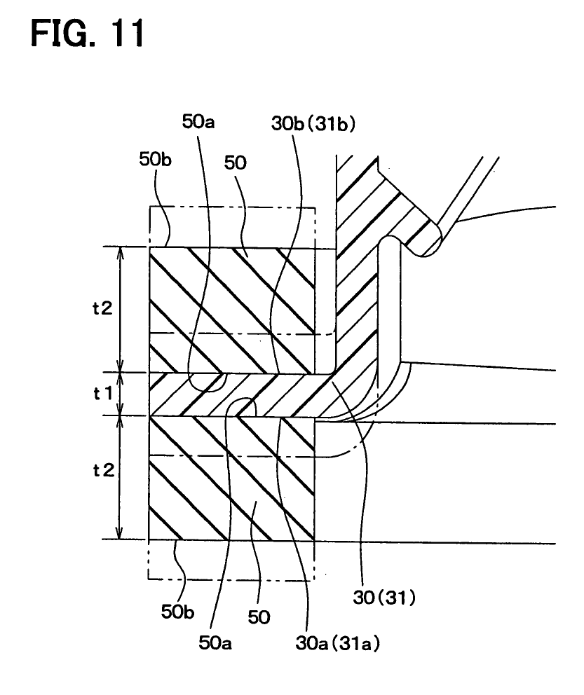

A second embodiment of the present invention will be described with reference to FIG. 11. FIG. 11 shows a portion of the air switching device 13 of the second embodiment, which corresponds to the portion shown in FIG. 7. In the second embodiment, the sealing structure of the door 17 is a packing-type sealing structure, in place of the lip-type sealing structure of the first embodiment. As shown in FIG. 11, packing members 50 as elastic members made of a porous resin are attached to the edges of the main body of the door 17.

For example, each of the flange portions 30, 31 of the edges of the door main body has two flat surfaces 30a, 30b, 31a, 31b facing in the door rotational direction. Each of the packing member 50 has a thin plate-like shape and a first surface 50a of each packing member 50 is fixed to the flat surface 30a, 30b, 31a, 31b. Namely, the packing members 50 are fixed to both surfaces 30a, 30b, 31a, 31b of each flange portion 30, 31.

A second surface 50b of each packing member 50 faces in the door rotational direction and is brought into contact with the corresponding case sealing surface 42, 43, 44, 45. Thus, the sealing effect is provided by elastically deforming or compressing the packing members 50 between the flange portions 30, 31 and the case sealing surfaces 42, 43, 44, 45.

Here, each packing members 50 has a constant thickness t2. As shown by double-dashed chain line in FIG. 11, the thickness t1 of each flange portion 30, 31 varies along the edges of the door main body. Thus, the second surface 50b of each packing member 50 is inclined relative to the corresponding case sealing surface 42, 43, 44, 45, though the thickness t2 of the packing members 50 is constant throughout the edges of the door main body.

In a condition that each of the second surfaces 50b is separated from the case sealing surface 42, 43, 44, 45, the second surface 50b is inclined such that a distance between the second surface 50b and the corresponding case sealing surface 42, 43, 44, 45 reduces from the driving side end toward the non-driving side end.

Namely, the second surfaces 50b of the packing members 50 are inclined relative to the case sealing surfaces 42, 43, 44, 45, in the similar manner as the inclination of the first and second lip portions 32a, 32b, 33a, 33b relative to the case sealing surfaces 42, 43, 44, 45 of the first embodiment. Therefore, the sealing effects similar to the first embodiment are provided.

In this embodiment, the second surfaces 50b of the packing members 50 are inclined by varying the thickness t1 of the flange portions 30, 31. Therefore, it is not necessary to vary the thickness t2 of the packing members 50. Accordingly, the packing members 50 are easily formed.

### Third Embodiment

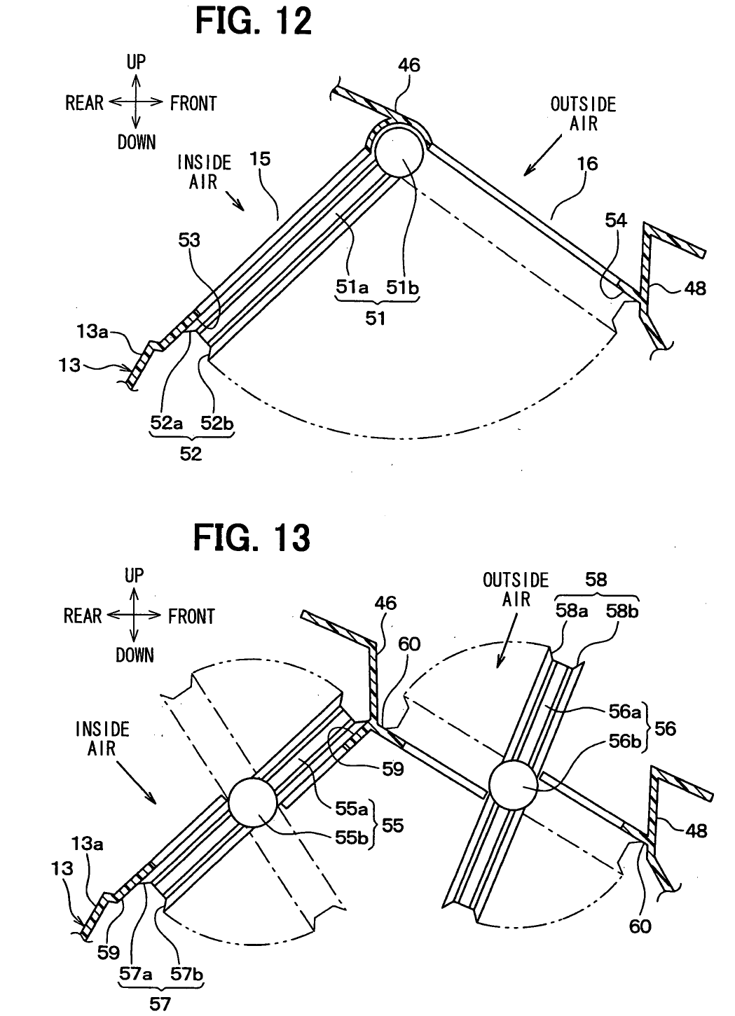

A third embodiment will be described with reference to FIG. 12. In the above embodiments, the inside/outside air switching door of the air switching device 13 is the rotary door 17. In the third embodiment, on the other hand, the inside/outside air switching door is a cantilever-type door 51 that has a door main body 51a and a rotation shaft 51b at an end of the door main body 51a, as shown in FIG. 12.

In the outside air mode, the door 51 is moved to an outside air mode position shown by a solid line in FIG. 12. Namely, in the outside air mode, the inside air suction port 15 is fully closed by the door 51 and the outside air suction port 16 is fully open. In the inside air mode, the door 51 is moved to an inside air mode position shown by a double-dashed chain line in FIG. 12. Namely, in the inside air mode, the outside air suction port 16 is fully closed by the door 51 and the inside air suction port 15 is fully open.

In this embodiment, the air switching device 13 is employed to the right-hand-drive vehicle, for example. Therefore, a left end of the rotation shaft 51b such as an end opposite to the air conditioning unit 12, that is, an end on a back side of a paper surface of FIG. 12, is rotatably supported by the shaft receiving end of the case 13a. On the other hand, a right end of the rotation shaft 51b, such as an end adjacent to the air conditioning unit 12, that is, an end on a front side of the paper surface of FIG. 12, is coupled to the driving device 29.

The door main body 51a has a rectangular plate shape. A sealing member 52 having the lip shape is fixed to the edges of the door main body 51a. Similar to the sealing members 32, 33 of the first embodiment, the sealing member 52 is made of the elastomer resin and integrally molded with the door main body 51a by double-shot molding.

Also, the sealing member 52 diverges into two pieces and projects on both sides of the door main body 51a. That is, the sealing member 52 has a substantially V-shape in cross-section. Therefore, the sealing member 52 is elastically deformable on both sides of the door main body 51a in the door rotational direction.

In other words, the sealing member 52 has a first lip portion 52a projecting on one side of the door main body 51a and a second lip portion 52b projecting on an opposite side of the door main body 51a, similar to the first and second lip portions 32a, 32b, 33a, 33b of the first embodiment.

The inside air suction port 15 defines a rectangular-shaped plane opening to correspond to the door main body 51a. The case 13a has case sealing surfaces 53, 54 on peripheral portions of the inside and outside air suction ports 15, 16. The door 51 is disposed such that the first and second lip portions 52a, 52b of the sealing member 52 are brought into contact with the case sealing surfaces 53, 54 and have surface contact with the case sealing surfaces 53, 54 in elastically deformed conditions.

The projection width W of the first and second lip portions 52a, 52b varies along the edges of the door main body 51a, in the similar manner as the first and second lip portions 32a, 32b, 33a, 33b of the first embodiment. Namely, the angle between the first and second lip portions 52a, 52b, which form the substantially V-shaped cross-section, is varied along the edges of the door main body 51a so that the first and second lip portions 52a, 52b are inclined relative to the case sealing surfaces 53, 54.

Specifically, in a radially outer edge of the door main body 51a, which extends in the axial direction, such as in a the vehicle right and left direction, that is, in a direction perpendicular to the paper surface of FIG. 12, the projection width W of the first and second lip portion 52a, 52b increases from a driving side such as a vehicle right side, that is, a front side of the paper surface of FIG. 12, toward a non-driving side, such as a vehicle left side, that is a back side of the paper surface of FIG. 12.

Also, in right and left edges (driving side edge and the non-driving side edge) of the door main body 51a, which extend in the radial direction, the projection width W of the first and second lip portions 52a, 52b reduces from the radially outer ends toward the radially inner ends. Further, the projection width W of the lip portions 52a, 52b of the left edge (non-driving side edge) is larger than the projection width W of the lip portions 52a, 52b of the right edge (driving side edge).

Accordingly, also in the cantilever type door 51, the similar effects as the first embodiment will be provided. Namely, even when the door 51 is twisted, the sealing effect is provided also on the non-driving side. Also, it is less likely that the radially inner ends of the first and second lip portions 52a, 52b will be brought into contact with the case sealing surfaces 53, 54 before the radially outer ends of the first and second lip portion 52a, 52b. As such, the sealing effect is sufficiently provided also in the radially outer ends of the door 51.

When the case 13a is employed in the left-hand-drive vehicle, the door 51 is assembled in the opposite direction as the direction in the right-hand-drive vehicle. Also in this case, the similar effects are provided.

Accordingly, the components of the air switching device 13 including the door 15 are used for both of the right-hand-drive vehicle and the left-hand-drive vehicle. Therefore, the efficiency for designing and manufacturing the vehicular air conditioning apparatus improves.

### Fourth Embodiment

A fourth embodiment will be described with reference to FIG. 13. In the fourth embodiment, the inside/outside air switching door is constructed of butterfly doors 55, 56. As shown in FIG. 13, each of the butterfly doors 55, 56 has a door main body 55a, 56a having a rectangular plate shape and a rotation shaft at a substantially middle position of the door main body 55a, 56a.

The door 55 is disposed to open and close the inside air suction port 15. The door 56 is disposed to open and close the outside air suction port 16. In the outside air mode, the door 55, 56 are moved to positions shown by solid lines in FIG. 13 so that the inside air suction port 15 is fully closed and the outside air suction port 16 is fully open. In the inside air mode, the door 55, 56 are moved to positions shown by double-dashed chain line in FIG. 13 so that the inside air suction port 15 is fully open and the outside air suction port 16 is fully closed.

In this embodiment, the air switching device 13 is employed to the right-hand-drive vehicle, for example. Therefore, left ends of the rotation shafts 55b, 56b, which are farther away from the air conditioning unit 12, such as the ends on back side of a paper surface of FIG. 13, are rotatably supported by the shaft receiving holes of the case 13a. On the other hand, right ends of the rotation shafts 55b, 56b, which are adjacent to the air conditioning unit 12, such as the ends on front side of the paper surface of FIG. 13, are coupled to the driving device 29.

Further, the doors 55, 56 have sealing members 57, 58, which have the lip shape, along the edges of the door main bodies 55a, 56a. The sealing members 57, 58 are made of the elastomer resin, similar to the sealing member 52 of the third embodiment. The sealing members 57, 58 are integrally molded with the resinous door main bodies 55a, 56a by double-shot molding.

Also, each of the sealing members 57, 58 diverges into two pieces and projects on both sides of the door main bodies 55a, 56a. Thus, each of the sealing member 57, 58 has a substantially V-shaped cross-section. The sealing members 57, 58 are deformable on both sides of the door main bodies 55a, 56a.

Specifically, each of the sealing members 57, 58 has a first lip portion 57a, 58a projecting on one side of the door main body 55a, 56a and a second lip portion 57b, 58b projecting on an opposite side of the door main body 55a, 56a.

The case 13a has case sealing surfaces 59, 60 on peripheries of the inside air suction port 15 and the outside air suction port 16. The door 55 is disposed such that the first and second lip portions 57a, 57b are brought into contact with the case sealing surface 59 and elastically deformed. Likewise, the door 56 is disposed such that the first and second lip portions 58a, 58b are brought into contact with the case sealing surface 60 and elastically deformed.

The projection width W of the first and second lip portions 57a, 57b, 58a, 58b varies along the edges of the door main bodies 55a, 56a, in the similar manner as the third embodiment. That is, the angle between the first and second lip portions 57a, 57b, 58a, 58b, which form the substantially V-shaped cross-section, is varied along the edges of the door main bodies 55a, 56a so that the first and second lip portions 57a, 57b, 58a, 58b are inclined relative to the corresponding sealing surfaces 59, 60.

Specifically, in radially outer ends of each sealing member 57, 58, which extend along the radially outer ends of the door main bodies 55a, 56a in the axial direction, the projection width W of each of the first and second lip portions 57a, 57b, 58a, 58b is increased from the driving side end, such as the right end in the vehicle right and left direction, that is, a front side of a paper surface of FIG. 13, toward the non-driving side end, such as left end in the vehicle right and left end, that is, a back side of the paper surface of FIG. 13.

Also, in axial end portions of each sealing member 57, 58, which extend along the axial ends of the door main bodies 55a, 56a in the radial direction, the projection width W of each of the first and second lip portions 57a, 57b, 58a, 58b reduces toward the rotation axis. Further, in the first and second lip portions 57a, 57b, 58a, 58b, the projection width W of the left axial ends, which are on the non-driving side, is larger than the projection width W of the right axial ends, which are on the driving side.

Accordingly, even when the inside/outside air switching door is constructed of the butterfly doors 55, 56, the similar effects as the third embodiment will be provided. Namely, the sealing effect is sufficiently provided even when the doors 55, 56 are twisted. Also, it is less likely that the radially inner portions of the first and second lip portions 57a, 57b, 58a, 58b will be brought into contact with the case sealing surfaces 53, 54 before the radially outer portions of the first and second lip portions 57a, 57b, 58, 58b. Therefore, even radially outer portions of the doors 55, 56 are effectively sealed with the case sealing surfaces 53, 54.

When the air switching device 13 is employed to the left-hand-drive vehicle, the doors 55, 56 are assembled such that the rotation shafts 55b, 56b extend opposite direction as the direction in the right-hand-drive vehicle. Therefore, even in the left-hand-drive vehicle, the similar effects are provided.

As such, the components of the air switching device 13 including the doors 55, 56 are used for both of the right-hand-drive vehicle and the left-hand-drive vehicle. Therefore, efficiency for designing and manufacturing the vehicle air conditioning apparatus improves.

### Other Embodiments

In the first embodiment, the inside air suction port 15 and the outside air suction port 16 are opened and closed by the single rotary door 17. Alternatively, the rotary door 17 may be provided to each of the inside air suction port 15 and the outside air suction port 16. That is, the inside air suction port 15 may be opened and closed by a first rotary door 17, and the outside air suction port 16 may be opened and closed by a second rotary door 17.

In the above embodiments, the sealing structures are employed to the doors of the air switching device 13. However, the use of the above sealing structures of the doors is not limited to the doors of the air switching device 13. For example, the above sealing structures may be employed on any other doors such as air mixing doors and air-blowing mode switching doors of the vehicular air conditioning apparatus.

Furthermore, the above sealing structures may be employed in various forms in any passage opening and closing devices. For example, the above sealing structures may be employed in passage opening and closing devices for air conditioning system for houses, buildings and the like.

The various exemplary embodiments of the present invention are described hereinabove. However, the present invention is not limited to the above described exemplary embodiments, but may be implemented in various other ways without departing from the spirit of the invention.

What is claimed is:

1. A passage opening and closing apparatus comprising:
a case defining a passage through which a fluid flows and a first opening in communication with the passage, the case having a first case-sealing surface on a periphery of the first opening;
a rotary door for opening and closing the first opening; and
a driving device for rotating the rotary door, wherein
the rotary door has a rotation shaft that includes a first shaft end and a second shaft end, a peripheral wall, a first side wall, and a second side wall,
the peripheral wall is disposed at a predetermined distance from an axis of the rotation shaft in a radially outward direction and is rotatable with the rotation shaft,
the first side wall connects a first axial end of the peripheral wall and the first shaft end of the rotation shaft,
the second side wall connects a second axial end of the peripheral wall and the second shaft end of the rotation shaft,
the first shaft end of the rotation shaft is rotatably supported by the case,
the second shaft end of the rotation shaft is coupled to the driving device,
the rotary door has a peripheral wall-sealing part along an edge of the peripheral wall, the peripheral wall-sealing part includes a first door-sealing surface that contacts the first case-sealing surface when the rotary door is in a first position at which the rotary door closes the first opening, and
the first door-sealing surface is configured to incline relative to the first case-sealing surface such that a distance between the first door-sealing surface and the case-sealing surface with respect to a rotational direction of the rotary door reduces toward a first end of the peripheral wall-sealing part from a second end of the peripheral wall-sealing part in a condition that the rotary door is in a position at which the first door-sealing surface is separated from the first case-sealing surface, the first end of the peripheral wall-sealing part being farther away than the second end of the peripheral wall-sealing part, with respect to the driving device.

2. The passage opening and closing apparatus according to claim 1, wherein
the peripheral wall-sealing part includes a lip portion projecting from the edge of the peripheral wall of the rotary door, and the first door-sealing surface is included in the lip portion, and
the first door-sealing surface is inclined by increasing a projecting width of the lip portion toward the first end of the peripheral wall sealing part from the second end of the peripheral wall-sealing part, the projecting width being defined by a dimension of the lip portion with respect to a direction parallel to the rotational direction of the rotary door.

3. The passage opening and closing apparatus according to claim 1, wherein
the rotary door includes a first side wall-sealing part along an edge of the first side wall and a second side wall-sealing part along an edge of the second side wall,
the first side wall-sealing part and the second side wall-sealing part contact the first case sealing surface when the rotary door is in the first position, and
a projecting width of the first side wall-sealing part is greater than that of the second side wall-sealing part, the projecting width of each of the first and second side wall-sealing parts being defined by a dimension thereof with respect to a direction parallel to the rotational direction.

4. The passage opening and closing apparatus according to claim 3, wherein
the edges of the first and second side walls extend in a radial direction, and
the projecting width of each of the first and second side wall-sealing parts reduces from a radially outer end of the edge toward a radially inner end of the edge.

5. The passage opening and closing apparatus according to claim 1, wherein
the case defines a second opening in communication with the passage and a second case-sealing surface on a periphery of the second opening,
the rotary door is movable between the first position at which the rotary door closes the first opening and opens the second opening and a second position at which the rotary door closes the second opening and opens the first opening,
the peripheral wall-sealing part includes a second door-sealing surface that contacts the second case-sealing surface when the rotary door is in the second position,
the second door-sealing surface is configured to incline relative to the second case-sealing surface such that a distance between the second door-sealing surface and the second case-sealing surface in the rotational direction reduces toward the first end of the peripheral wall-sealing part from the second end of the peripheral wall-sealing part in a condition that the rotary door is in a position at which the second door-sealing surface is separated from the second case-sealing surface.

6. A passage opening and closing apparatus comprising:
a case defining a passage through which a fluid flows and an opening in communication with the passage, and having a case-sealing surface on a periphery of the opening,
a door for opening and closing the opening of the case; and
a driving device for rotating the door, wherein
the door includes a rotation shaft and a door main body rotatable with the rotation shaft,
the rotation shaft includes a first shaft end rotatably supported by the case and a second shaft end coupled to the driving device,
the door has a door-sealing part along at least an edge of the door main body, the edge extending in a direction parallel to an axis of the rotation shaft,
the door-sealing part contacts the case-sealing surface when the door is in a closed position at which the door main body closes the opening,
the door-sealing part is configured to incline such that a distance between
the door-sealing part and the case-sealing surface in a rotational direction of the door reduces toward a first end of the edge of the door main body from a second end of the door main body, the first end of the edge being farther away than the second end of the edge, with respect to the driving device.

7. A passage opening and closing apparatus comprising:
a case defining a passage through which a fluid flows and a first opening in communication with the passage, and having a first case-sealing surface on a periphery of the first opening;
a door disposed to the case for opening and closing the first opening; and
a driving device for driving the door, wherein
the door includes a rotation shaft having a rotation axis and a door main body rotatable with the rotation shaft,
the rotation shaft includes a first shaft end rotatably supported by the case and a second shaft end coupled to the driving device,
the door is rotatable between a first position at which the door main body closes the first opening and a second position at which the door main body opens the first opening,
the door further includes a door-sealing part along an edge of the door main body, the edge extending in an axial direction, the door-sealing part includes a first door-sealing surface that contacts the first case-sealing surface when the door is in the first position,
the door-sealing part further includes a width in the rotational direction, the width increasing toward a first end of the edge of the door main body from a second end of the edge of the door main body, the first end of the edge being farther away than the second end of the edge with respect to the driving device.

8. The passage opening and closing apparatus according to claim 7, wherein
the case defines a second opening in communication with the passage,
when the door is in the first position, the second opening is open, and when the door is in the second position, the door main body closes the second opening,
the door-sealing part has a second door-sealing surface opposite to the first door-sealing surface with respect to the rotational direction,
the case further has a second case-sealing surface that contacts the second door-sealing surface when the door is in the second position, and
the width of the door-sealing part is defined by a distance between the first door-sealing surface and the second door-sealing surface.

9. The passage opening and closing apparatus according to claim 8, wherein
the door-sealing part includes a first lip portion and a second lip portion projecting from the edge of the door main body,
the first lip portion and the second lip portion define an angle therebetween,
the first door-sealing surface is included in the first lip portion and the second door-sealing surface is included in the second lip portion, and
the width of the door-sealing part is increased by increasing the angle between the first and second lip portions.

10. The passage opening and closing apparatus according to claim 9, wherein
the door main body includes a peripheral wall disposed at a predetermined distance from the rotation shaft in a radially outward direction, a first side wall extending from a first axial end of the peripheral wall to the first shaft end, and a second side wall extending from a second axial end of the peripheral wall to the second shaft end, and
the edge of the door main body along which the door-sealing part is disposed is provided by an end of the peripheral wall.

11. The passage opening and closing apparatus according to claim 9, wherein
the door main body includes a plate member, and a first end of the plate member is connected to the rotation shaft, and
the edge of the door main body along which the door-sealing part is disposed is provided by a second end of the plate member.
